(19) United States
(12) Patent Application Publication
(10) Pub. No.: US 2026/0125980 A1
(43) Pub. Date: May 7, 2026

(54) STEERING CONTROL DEVICE OF SHIELD TBM AND STEERING CONTROL METHOD USING THE SAME

(71) Applicant: KOREA INSTITUTE OF CIVIL ENGINEERING AND BUILDING TECHNOLOGY, Goyang-si (KR)

(72) Inventors: Soo-Ho CHANG, Seoul (KR); Soon-Wook CHOI, Goyang-si (KR); Tae-Ho KANG, Seoul (KR); Chulho LEE, Gimpo-si (KR)

(73) Assignee: KOREA INSTITUTE OF CIVIL ENGINEERING AND BUILDING TECHNOLOGY, Goyang-si (KR)

(21) Appl. No.: 19/312,634

(22) Filed: Aug. 28, 2025

(30) Foreign Application Priority Data
Nov. 4, 2024 (KR) 10-2024-0154565

(51) Int. Cl. E21D 9/093; E21D 9/087

(52) U.S. Cl. CPC E21D 9/093; E21D 9/087

(57) ABSTRACT

The present disclosure relates to a steering controller of a shield tunnel boring machine (TBM) and a steering control method using the same. To this end, the steering controller of the shield TBM individually controls operating lengths of articulation jacks, which are provided between a front shield having a cutter head and a middle shield and are radially spaced at equal intervals along a pre-designed excavation path. The method comprises: extracting reference point coordinates of the cutter head at a current point and reference point coordinates of the cutter head at a target point according to one cycle operation of shield jacks; calculating the operating lengths of each articulation jack as continuous real number values based on the reference point coordinates at the current point and the reference point coordinates at the target point; and simultaneously operating each articulation jack according to the calculated operating lengths.

### CROSS-REFERENCE TO RELATED APPLICATION

This application claims priority under 35 U.S.C § 119 to Korean Patent Application No. 10-2024-0154565 filed on Nov. 4, 2024, in the Korean Intellectual Property Office, the entire contents of which are hereby incorporated by reference.

### TECHNICAL FIELD

The present disclosure relates to a steering controller of a shield tunnel boring machine (TBM) and a steering control method using the same, and more particularly, to a steering controller of a shield TBM and a steering control method using the same, in which the steering controller calculates the operating length of each articulation jack based on reference point coordinates of a current point and reference point coordinates of a target point by using an artificial intelligence calculation model, and simultaneously operates each articulation jack according to the calculated operating length, thereby ensuring accuracy even in curved excavation.

### BACKGROUND

Unlike the New Austrian Tunneling Method (NATM) method using blasting, the shield TBM method is a construction method in which a cylindrical shield machine is introduced into a temporary working shaft, the cutter head mounted at the front is rotated to excavate the tunnel face, and segment rings are simultaneously assembled inside to achieve early ground stabilization and high quality.

As illustrated in FIG. 1A, the cylindrical shield machine includes a front shield and a middle shield for excavation, as well as shield jacks and articulation jacks that connect the shields. The shield jacks directly or indirectly operate the front shield and are used in the case of straight or nearly straight excavation, and move the cutter head forward by a depth corresponding to the width of the segment ring during the excavation process. Meanwhile, when the tunnel alignment includes straight and sharply curved sections, articulation jacks located between the front shield and the middle shield are used along with the shield jacks. In this case, the articulation jacks are first adjusted to correspond to a predetermined articulation angle, and then the shield jacks are extended to perform the excavation.

Also, as illustrated in FIG. 1B, depending on the position of the articulation point by the articulation jack, the articulation system is classified into a V-type and an X-type. (a) In the X-type, a rotation pin is located at the articulation point to connect the front shield and the middle shield, so the articulation angle is small, but it is advantageous in articulation sealing and waterproofing. (b) In the V-type, since the articulation point is located on a shield skin plate, the articulation angle is large, but it has the disadvantage of being difficult to prevent the inflow of excavated soil and water.

Korean Patent Application Publication No. 10-2022-0033323, entitled “TBM Operation System” (published on Mar. 16, 2022, hereinafter referred to as “prior art document”), is intended to monitor and control the state of a TBM in real time, and discloses a technical configuration in which, when a user inputs an operation signal for the TBM via an operation panel including a controller, a control part controls the TBM according to the input operation signal, and a display part outputs the state of the TBM.

However, in the prior art including the prior art document, the conventional TBM controller has a drawback in that accurate excavation is difficult depending on the user's proficiency, since the user directly controls the rotation of the cutter and the operation of the main jacks and articulation jacks. More importantly, in curved excavation, there is a difficulty in that excavation must follow a three-dimensional curve having curvature not only in an x-y plane but also in a z-axis direction. In addition, the articulation jacks provided between the shields are arranged in plurality along the circumference of the shield, and must be contracted or extended in different lengths and directions for each articulation jack. Accordingly, when the user directly controls the system through manual judgment, errors are inevitably generated due to such limitations.

In particular, the conventional TBM controller focuses on a measurement system using a gyroscope, an accelerometer, and a magnetometer for directional control, and it has been recognized as impossible to mathematically calculate a multi-solution problem caused by the complex operation of the articulation jacks and the shield jacks.

Furthermore, as illustrated in FIG. 2, even when a user performs accurate operation control, there is a limitation in that pitch, yaw, and roll rotations inevitably occur during the forward movement of the TBM due to ground characteristics and the weight of the machine. Therefore, even if a skilled user controls the TBM based on given drawing information, accurate excavation is difficult due to real-time errors that occur, and this problem is more serious in the case of curved excavation.

### PRIOR ART DOCUMENTS

### Patent Document

(Patent Document 1) Korean Patent Application Publication No. 1997-0044027 (published on Jul. 26, 1997)
(Patent Document 2) Korean Patent Application Publication No. 10-2022-0033323 (published on Mar. 16, 2022)

### SUMMARY

The present disclosure has been devised to solve the above-described problems of the conventional art, and an object thereof is to provide a steering controller of a shield tunnel boring machine TBM and a steering control method using the same, which may implement accurate steering control along a pre-designed excavation path without relying on the user's manual judgment. In particular, in controlling a plurality of articulation jacks during curved excavation, the steering controller may calculate the operating length of each articulation jack accurately by using an artificial intelligence calculation model, thereby enabling continuous control that is not discrete, and even if some errors occur due to pitch, yaw, and roll during the excavation process, the steering controller may perform real-time calculation each time the shield jack is operated, so that deviation from the excavation path due to accumulated error may not occur, and may further verify whether the excavation path predicted based on the calculation conforms to the target.

To achieve the above object, a steering control method CM using a steering controller of a shield TBM according to the present disclosure is configured such that a steering controller SC of the shield TBM individually controls the operating lengths of at least four articulation jacks 3 that are provided between a front shield 1, which is equipped with a cutter head 1a, and a middle shield 2, and are radially spaced at equal intervals along the excavation path, the method includes: a step S10 in which the steering controller SC extracts reference point coordinates T_{c} of the cutter head 1a at a current point and reference point coordinates Tₜ of the cutter head 1a at a target point according to one cycle operation of a shield jack 4; a step S20 in which the steering controller SC calculates operating lengths l of each articulation jack 3 by using an artificial intelligence calculation model based on the reference point coordinates T_{c} of the current point and the reference point coordinates Tₜ of the target point; and a step S40 in which the steering controller SC simultaneously operates each articulation jack 3 according to the calculated operating lengths l.

The method may further include a step S00 in which the steering controller SC receives input of coordinates according to a pre-designed three-dimensional tunnel path.

Also, the artificial intelligence calculation model may receive the diameter D of the cutter head 1a and articulation angles α and β according to the reference point coordinates T_{c} and Tₜ of the current point and the target point, and may calculate the operating lengths l of each articulation jack 3 within the operating range.

Also, the artificial intelligence calculation model may be a prediction model using a repetitive loop including: a step S21A of generating random numbers for the operating lengths l within the operating range of each articulation jack 3; a step S22A of calculating articulation angles α_{cal} and β_{cal} according to the operating lengths l of each articulation jack 3 based on the generated random numbers; a step S23A of comparing the calculated articulation angles α_{cal} and β_{cal} with the articulation angles αᵢₙ and βᵢₙ according to the reference point coordinates T_{c} and Tₜ of the current point and the target point; and a step S24A of extracting the generated random numbers as valid operating lengths l of each articulation jack 3 if the calculated articulation angles α_{cal} and β_{cal} are within an error range, or returning to the step S21A of generating random numbers if they are outside the error range.

Also, the step S21A of generating random numbers may partially limit the range of random number generation centered on the valid operating lengths l of each articulation jack 3 extracted in the previous cycle.

Also, the artificial intelligence calculation model may be a machine learning model for regression calculation, which is generated by training a data set that includes diameter D and articulation angles α and β as input variables and operating length l as an output variable.

Also, the steering controller SC may further include a step S25 of outputting the calculated operating lengths l of each articulation jack 3 on a display.

Also, the steering controller SC may further include a step S30 of verifying whether to operate by comparing the predicted reference point coordinates Tₚ of the cutter head 1a when each articulation jack 3 operates according to the calculated operating lengths l, with the reference point coordinates Tₜ of the cutter head 1a at the target point.

Meanwhile, the steering controller SC of the shield TBM according to the present disclosure includes: a memory in which an application program is stored to provide a steering control method for individually controlling the operating lengths of at least four articulation jacks 3 that are provided between a front shield 1, which is equipped with a cutter head 1a, and a middle shield 2, and are radially spaced at equal intervals along the excavation path; and a processor configured to execute the application program stored in the memory, wherein the processor, by executing the application program, extracts the reference point coordinates T_{c} of the cutter head 1a at a current point and the reference point coordinates Tₜ of the cutter head 1a at a target point according to one cycle operation of a shield jack 4, calculates the operating lengths l of each articulation jack 3 based on the reference point coordinates T_{c} of the current point and the reference point coordinates Tₜ of the target point by using an artificial intelligence calculation model, and verifies whether to operate by comparing the predicted reference point coordinates Tₚ of the cutter head 1a with the reference point coordinates Tₜ of the cutter head 1a at the target point when each articulation jack 3 operate according to the calculated operating lengths l, and the steering controller SC simultaneously operates each articulation jack 3 based on the calculated operating lengths l.

And the articulation jacks 3 may be arranged in four positions spaced apart around a rotation pin located at the center of the shield, and the sum of the operating lengths lᵤ and l_{d} of the upper and lower articulation jacks and the sum of the operating lengths lₗ and lᵣ of the left and right articulation jacks may be controlled to be constant at all times.

By calculating the operating lengths of each articulation jack based on the reference point coordinates of the current point and the reference point coordinates of the target point using an artificial intelligence calculation model, the steering controller SC may implement accurate steering control along a pre-designed excavation path without relying on the user's manual judgment.

In particular, even in cases where precision is required, such as curved excavation, the plurality of articulation jacks may be continuously and accurately controlled by the operating lengths rather than through discrete control, according to the calculation of the artificial intelligence calculation model, so that the curved excavation may be performed within an allowable error range.

Also, even if some errors occur between the actual excavation path and the designed excavation path due to pitch, yaw, or roll of the shield during the excavation process, deviation from the excavation path caused by accumulated errors may be prevented in advance by performing real-time calculation each time the shield jack is operated in a cycle.

Furthermore, the operating lengths of each articulation jack calculated by the artificial intelligence calculation model may be immediately output to a display so that the user may determine whether to operate the articulation jacks, and, depending on the embodiment, when each articulation jack operate according to the calculated operating lengths, the predicted reference point coordinates may be compared with the target reference point coordinates to further verify whether to operate.

### BRIEF DESCRIPTION OF THE DRAWINGS

FIG. 1A is a conceptual diagram schematically illustrating the structure of a conventional shield TBM.

FIG. 1B is a conceptual diagram illustrating different articulation systems of a conventional shield TBM.

FIG. 2 is a conceptual diagram for explaining pitch, yaw, and roll phenomena occurring in the shield.

FIG. 3 is a flowchart illustrating a steering control method according to an embodiment of the present disclosure in chronological order.

FIG. 4 is a conceptual diagram schematically illustrating the structure of a shield TBM for explaining a steering control method according to an embodiment of the present disclosure.

FIGS. 5A to 5D are simulation images illustrating an excavation path formed when continuous excavation is performed according to an articulation angle.

FIG. 6 is a conceptual diagram schematically illustrating steering of a cutter head according to the operation of articulation jacks in the shield TBM structure of FIG. 4.

FIG. 7 is a conceptual diagram schematically illustrating excavation according to the operation of shield jacks in the shield TBM structure of FIG. 4.

FIGS. 8A to 8D are simulation images illustrating excavation paths according to the steering control method using the artificial intelligence model of the present disclosure.

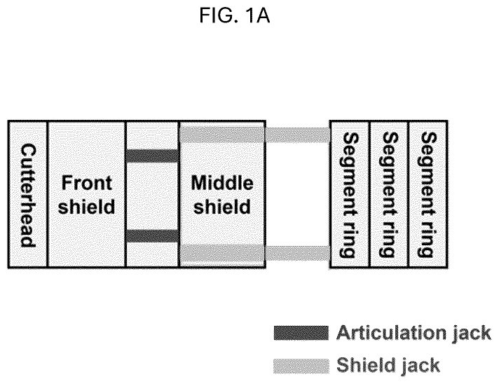

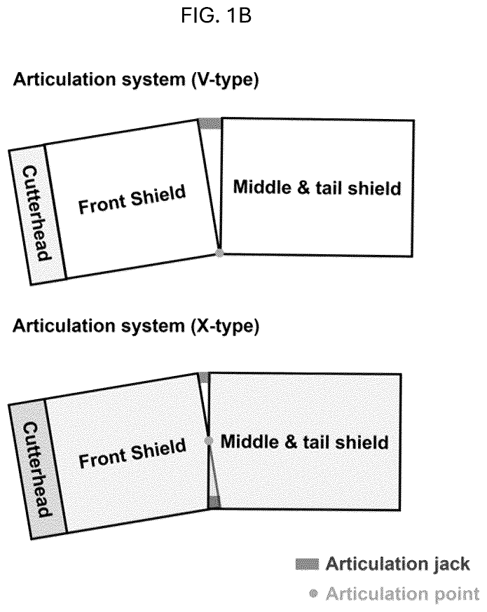

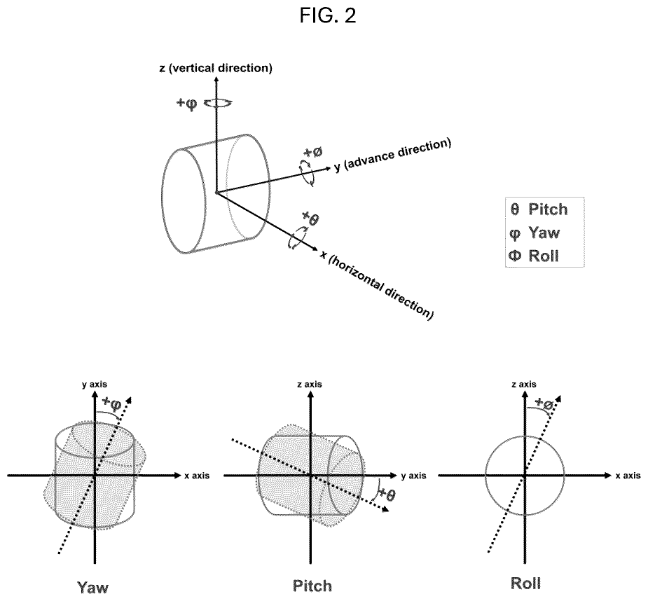

### DETAILED DESCRIPTION OF THE PREFERRED EMBODIMENTS

Hereinafter, a preferred embodiment of the present disclosure will be described in detail based on the matters illustrated in the drawings. However, detailed descriptions of related known functions or configurations will be omitted when it is determined that such descriptions may unnecessarily obscure the gist of the present disclosure.

The shield TBM, which is the control target of the present disclosure, adopts an X-type articulation system, and includes at least four articulation jacks 3 that are provided between a front shield 1, which is equipped with a cutter head 1a, and a middle shield 2, and are radially spaced at equal intervals, and includes a plurality of shield jacks 4 that are directly or indirectly connected to the front shield 1, supported by segment rings 5 continuously installed on the excavation surface, and apply propulsion force. In this case, a tail shield may be additionally provided at the rear of the middle shield 2.

The steering controller SC of the shield TBM according to the present disclosure comprises: a memory in which an application program for providing a steering control method of the shield TBM is stored; and a processor for executing the application program stored in the memory, and is configured to calculate, by an artificial intelligence calculation model, the operating lengths l of each articulation jack 3, based on the reference point coordinates T_{c} of the current point and the reference point coordinates Tₜ of the target point, and to simultaneously operate the each radially spaced articulation jack 3 according to the calculated operating lengths l, thereby enabling continuous control so that precise excavation is implemented within an allowable error range even when a curve is included in the pre-designed excavation path.

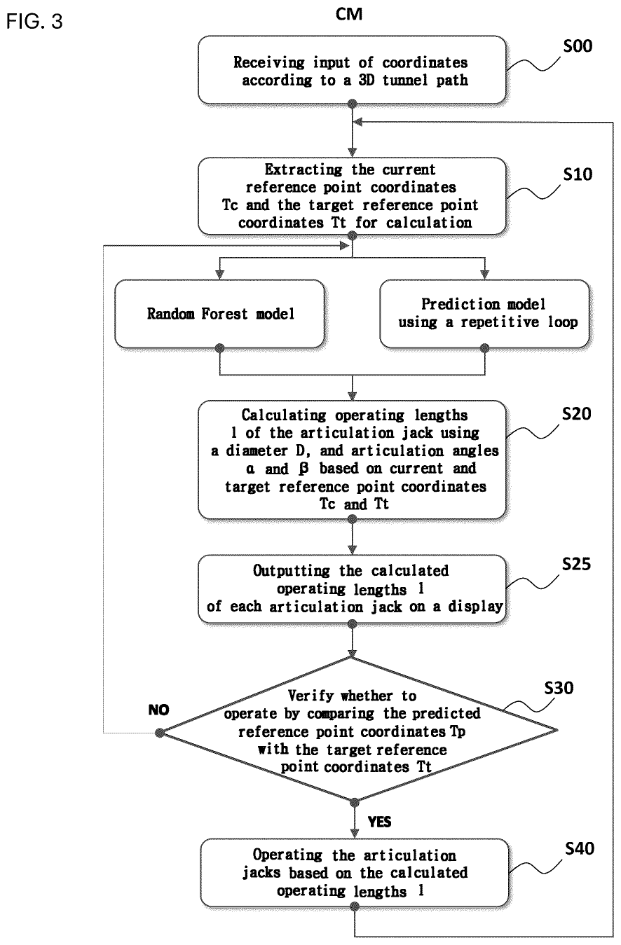

Hereinafter, the steering control method CM executed by the steering controller SC will be described in detail first. FIG. 3 is a flowchart illustrating the steering control method CM according to an embodiment of the present disclosure in chronological order.

First, the steering controller SC receives input of coordinates according to a pre-designed three-dimensional tunnel path (S00). It is preferable that the coordinates according to the tunnel path are specified to match the reference point coordinates T of the cutter head 1a of the shield TBM, which will be described later. The tunnel path coordinates may be stored in the memory in the form of structured data and then loaded, or may be input from an external storage device.

The steering controller SC extracts the reference point coordinates T_{c} of the cutter head 1a at a current point and the reference point coordinates Tₜ of the cutter head 1a at a target point according to one cycle operation of the shield jack 4, by using the coordinates of the three-dimensional tunnel path (S10).

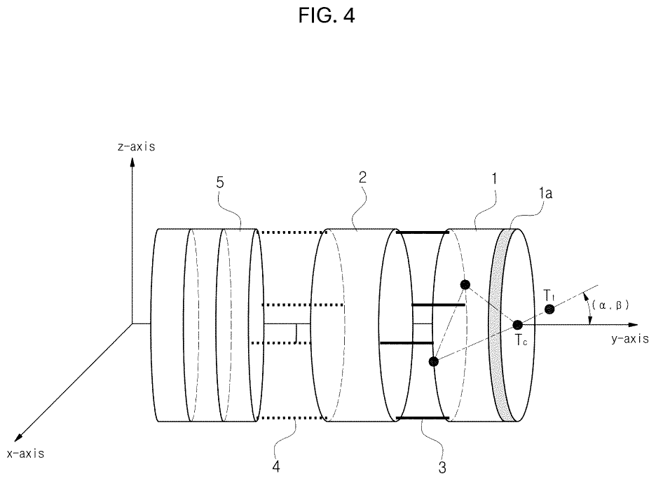

It is preferable that the reference point coordinates T include the coordinates of a front reference point of the cutter head 1a, and depending on the embodiment, may additionally include a rear-left point and a rear-right point of the front shield 1 so that the posture of the front shield 1 caused by pitch and yaw is reflected, as illustrated in FIG. 4. Although the predicted reference point coordinates Tₚ calculated in the previous cycle may be directly used as the reference point coordinates T_{c} of the cutter head 1a at the current point, but real-time coordinates of the reference point of the cutter head 1a may also be measured using a gyro sensor and an accelerometer so that errors caused by pitch, yaw, and roll during the excavation process are reflected.

In this case, it is preferable that the articulation angles α and β according to the reference point coordinates T_{c} and Tₜ of the current point and the target point are extracted together. The articulation angles include a horizontal angle α and a vertical angle β, where the horizontal angle α refers to the angle on an x-y plane and the vertical angle β refers to the angle on a y-z plane. That is, the articulation angles α and β may be extracted together by a vector connecting the reference point coordinates T_{c} and Tₜ of the current point and the target point.

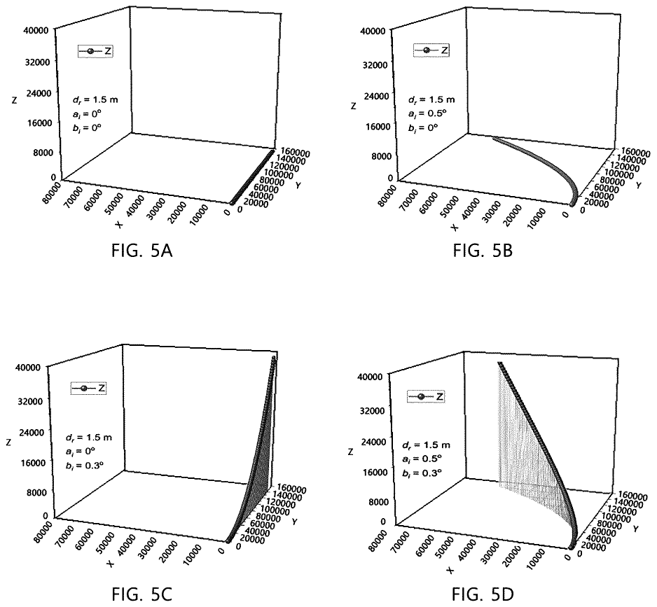

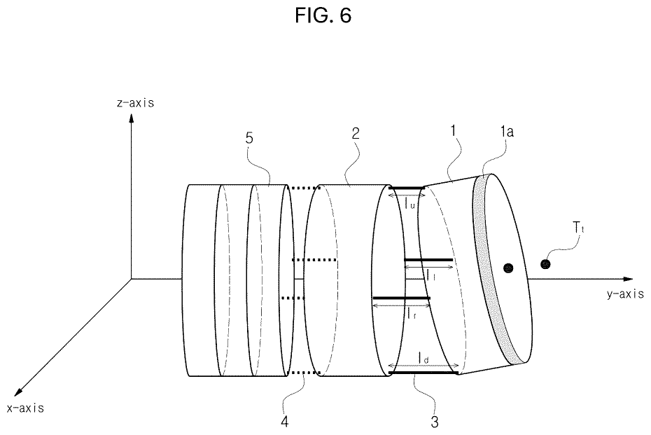

FIGS. 5A to 5D are simulation images illustratively showing an excavation path formed when excavation is continuously performed according to the articulation angles α and β, for the purpose of better understanding, where: (a) shows a case in which both articulation angles α and β are 0°, (b) shows a case in which the vertical angle β is 0°, (c) shows a case in which the horizontal angle α is 0°, and (d) shows a case in which neither the horizontal angle α nor the vertical angle β is 0°.

Next, the steering controller SC calculates the operating lengths l of each articulation jack 3 based on the reference point coordinates T_{c} of the current point and the reference point coordinates Tₜ of the target point by using an artificial intelligence calculation model (S20). The artificial intelligence calculation model may receive the diameter D of the cutter head 1a and the articulation angles α and β according to the reference point coordinates T_{c} and Tₜ of the current point and the target point, and may calculate and output the operating lengths l of each articulation jack 3 within an operating range as continuous real number values.

Meanwhile, the artificial intelligence calculation model may be implemented in various ways to calculate the operating lengths l of the articulation jacks 3, but the present disclosure proposes two types of calculation models, and descriptions of each artificial intelligence calculation model will be provided in more detail below.

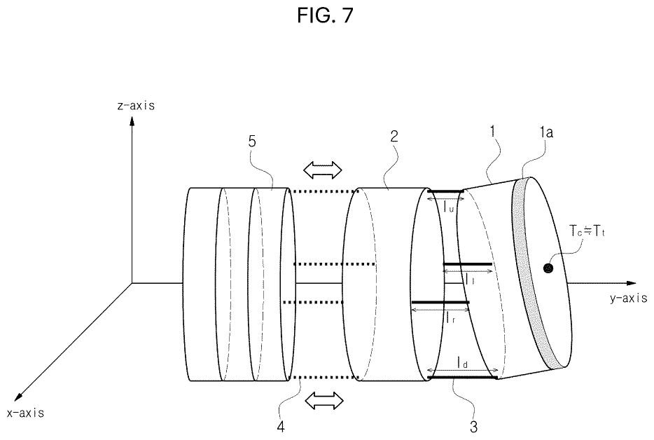

In the following two embodiments, the articulation jacks 3 are described based on a configuration in which four jacks are radially spaced, and the symbols lᵤ, l_{d}, lₗ and lᵣ for operating lengths respectively indicate the operating lengths of an upper articulation jack, a lower articulation jack, a left articulation jack, and a right articulation jack. That is, as illustrated in FIG. 6, the operating lengths lᵤ, l_{d}, lₗ and lᵣ of each articulation jack must be determined for curved excavation, and as illustrated in FIG. 7, the operating lengths lᵤ, l_{d}, lₗ and lᵣ must be controlled as continuous real number values so that the reference point coordinates T_{c} of the current point approximate the reference point coordinates Tₜ of the target point when the shield jack 4 is finally operated.

### <Prediction Model Using a Repetitive Loop>

The artificial intelligence calculation model according to an embodiment is a prediction model using a repetitive loop, and may be formulated as the following optimization problem to find the optimal operating lengths l for the input variables, i.e., the diameter D and the articulation angles α and β:
MINIMIZE [α_{cal}−αᵢₙ] and [β_{cal}−βᵢₙ]
subject to 0≤lᵤ, l_{d}, lₗ, lᵣ≤200 mm
(where α_{cal} and β_{cal} are articulation angles according to the calculation result, and αᵢₙ and βᵢₙ are target articulation angles.)

More specifically, the artificial intelligence calculation model generates random numbers for the operating lengths lᵤ, l_{d}, lₗ and lᵣ within the operating range of each articulation jack 3 (S21A). In this case, the random numbers are generated as positive values within the range of 200 mm, which is the operable length of each articulation jack 3, and are generated as continuous real number values.

Subsequently, the artificial intelligence calculation model uses the generated random numbers as the operating lengths lᵤ, l_{d}, lₗ and lᵣ of each articulation jack 3, calculates the corresponding articulation angles α_{cal} and β_{cal} (S22A), and compares the calculated articulation angles α_{cal} and β_{cal} with the articulation angles αᵢₙ and βᵢₙ according to the reference point coordinates T_{c} and Tₜ of the current point and the target point (S23A).

In this case, when the calculated articulation angles α_{cal} and β_{cal} are within an error range preset by the user with respect to the target articulation angles αᵢₙ and βᵢₙ, the generated random numbers are extracted as the valid operating lengths lᵤ, l_{d}, lₗ and lᵣ of each articulation jack 3, and when they are outside the error range, the process returns to the step S21A of generating random numbers and repeatedly performs the above-described process (S24A).

Meanwhile, in the prediction model using the above-described repetitive loop, since the articulation angles α_{cal} and β_{cal} are calculated based on randomly generated values and compared with the target articulation angles αᵢₙ and βᵢₙ, the calculation time may be delayed. To address this, in compiling the prediction model using the repetitive loop, it is preferable to perform Just-In-Time (JIT) compilation, which translates the program into machine code at the time of actual execution, and to implement multiprocessing so that parallel calculation is performed during the random search based on the generated random numbers.

In addition, by applying a probabilistic optimization technique, which is a type of Monte Carlo method, in the generation of random numbers, valid operating lengths lᵤ, l_{d}, lₗ and lᵣ may be quickly extracted even when continuous real number values are generated, and by partially limiting the range of random number generation around the valid operating lengths extracted in the previous cycle, high accuracy may be achieved while also reducing calculation time.

In particular, by utilizing the prediction model using the repetitive loop, it is possible to omit a pre-training procedure of collecting a large amount of data in advance for specific conditions and repeatedly training the collected data, thereby providing an advantage of implementing a fast calculation module as compared to other deep learning or machine learning models.

### <Random Forest Model>

According to another embodiment, the artificial intelligence calculation model is a Random Forest model for regression calculation, which is a model that predicts the operating lengths l as continuous real number values based on the input variables, i.e., the diameter D and the articulation angles α and β.

More specifically, after collecting a large amount of data set including diameter D and articulation angles α and β as input variables, and including operating lengths lᵤ, l_{d}, lₗ and lᵣ of four individual articulation jacks 3 as output variables, a decision tree is constructed by dividing the data set into a training data set and a test data set and training the training data set.

In addition, in evaluating the model using the test data set, mean squared error (MSE) and R-squared (R²) scores may be used so that prediction accuracy and model fitness are improved through training. Furthermore, for model optimization, the generalization performance of the model may be further improved through K-fold cross validation, and optimal hyperparameters of the Random Forest model may be identified using Grid Search or Random Search.

Meanwhile, the machine learning model for the regression calculation may of course be implemented as a polynomial regression model, a support vector model, a gradient boosting model, an artificial neural network (ANN) model, or a Gaussian process regression (GPR) model, etc.

As described above, when the steering controller SC calculates the operating lengths l of each articulation jack 3 by using the artificial intelligence calculation model, the steering controller SC may output the calculated operating lengths l of each articulation jack 3 via a display so that the user can check the values (S25). In this case, together with the operating length l, the error rate or prediction accuracy according to the artificial intelligence calculation model is output, so that the user may select whether to operate with the operating length l of the articulation jacks 3.

In addition, the steering controller SC may verify whether to operate by comparing the predicted reference point coordinates Tₚ of the cutter head 1a, when each articulation jack 3 operate according to the calculated operating lengths l, with the target reference point coordinates Tₜ (S30).

As such, in a case where it is difficult to determine whether to operate based on the operating length l, the error rate, or the prediction accuracy of the articulation jacks 3 that are presented only as numerical values, a direct comparison may be made based on the predicted reference point coordinates Tₚ at the time of operation and the reference point coordinates Tₜ of the target point. In this case, the result of the comparison between the automatically calculated reference point coordinates Tₚ and Tₜ by the steering controller SC may also be output via a display.

Finally, when an operation command is issued by the user, the steering controller SC simultaneously operates each articulation jack 3 based on the calculated operating lengths l (S40), and then the shield jack 4 operates along with the rotation of the cutter head 1a, thereby completing one cycle of the excavation operation. At this time, since the operating speeds of each articulation jack 3 are the same, the operating lengths l of each articulation jack 3 are proportional to the operating time.

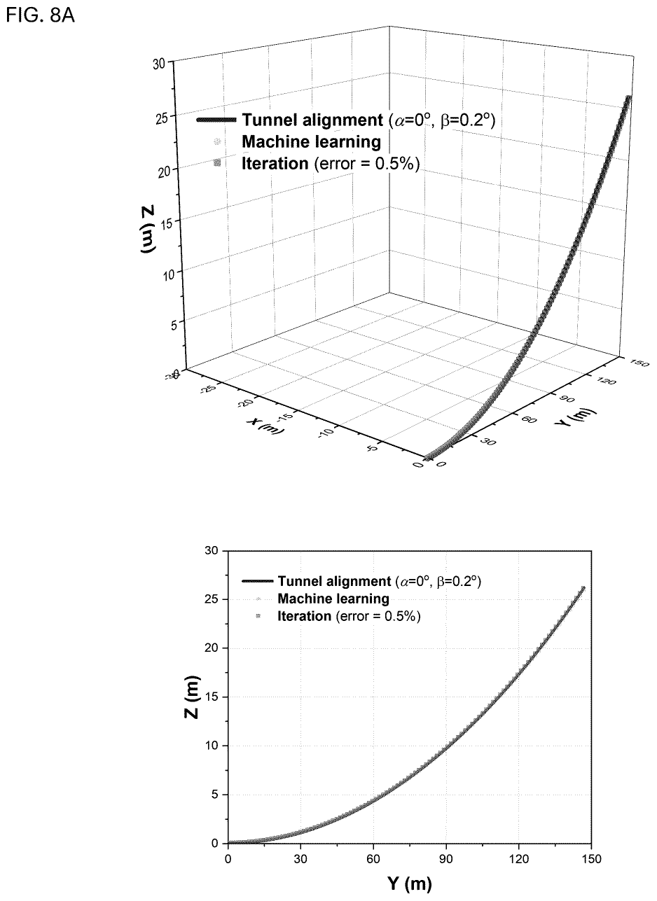

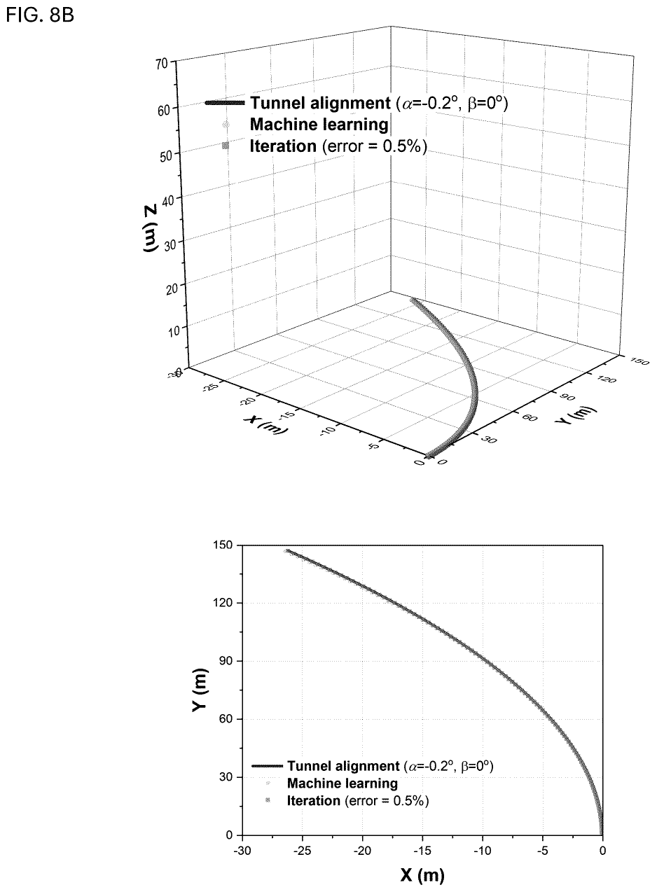

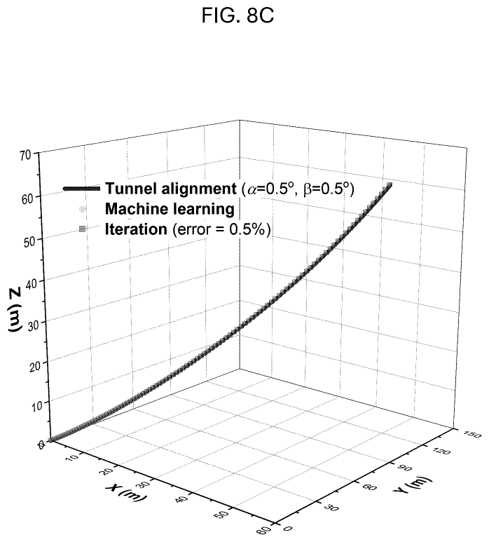

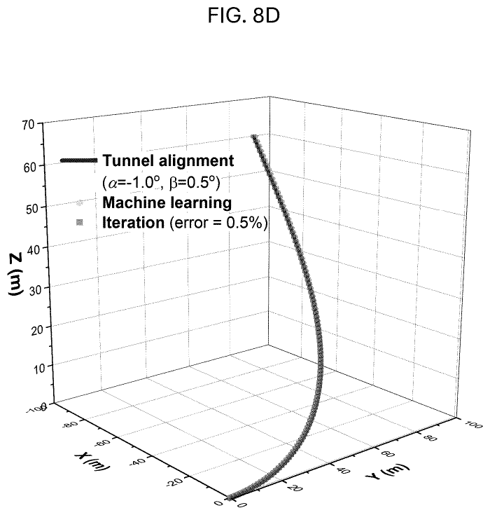

Meanwhile, FIGS. 8A to 8D are simulation images exemplarily showing excavation paths resulting from performing the steering control method of the present disclosure by using an artificial intelligence model, specifically a prediction model using an iterative loop having an error range of 0.5% (Iteration) and a Random Forest model (Machine learning). In this case, the reflected diameter D of the cutter head 1a is 8,000 mm, the length lF of the front shield is 3,000 mm, the lengths of the segment ring 5 and the operating length of the shield jack 4 are 1,500 mm, and the operating speed of the shield jack is 10 mm/sec. The simulation was performed on the basis of 100 cycles of operation.

Specifically, FIG. 8A shows the result of an excavation simulation for a shield TBM tunnel with an upward slope of 0.2° (α=0°, β=0.2°); FIG. 8B shows the result of an excavation simulation for a shield TBM tunnel with a leftward slope of 0.2° (α=0.2°, β=0°); FIG. 8C shows the result of an excavation simulation for a shield TBM tunnel with an upward-rightward slope (α=0.5°, β=0.5°); and FIG. 8D shows the result of an excavation simulation for a shield TBM tunnel with an upward-leftward slope (α=1.0°, β=0.5°), confirming that the excavation path accurately matches the designed three-dimensional tunnel path.

Meanwhile, the steering controller SC of the shield TBM according to the present disclosure is a computing device that performs the shield TBM steering control method CM described above, and detailed descriptions of the overlapping content regarding the steering control method CM will be omitted.

The present disclosure provides a steering control method CM for individually controlling the operating lengths of at least four articulation jacks 3, which are radially spaced apart at equal intervals and provided between a front shield 1 equipped with a cutter head 1a and a middle shield 2, along a pre-designed excavation path. The steering controller SC includes a memory in which an application program is stored, and a processor configured to execute the application program stored in the memory.

As the processor of the steering controller SC executes the application, it receives coordinates according to a pre-designed three-dimensional tunnel path, and extracts a reference point coordinate T_{c} of the cutter head 1a at a current point and a reference point coordinate Tₜ of the cutter head 1a at a target point according to one cycle of operation of the shield jack 4.

The processor calculates the operating lengths l of each articulation jack 3 as continuous real values by using an artificial intelligence calculation model linked to the application program, based on the reference point coordinate T_{c} at the current point and the reference point coordinate Tₜ at the target point, and simultaneously operates each articulation jack 3 according to the calculated operating lengths l.

At this time, the processor may verify whether to operate by comparing a predicted reference point coordinate Tₚ of the cutter head 1a, which is expected when each articulation jack 3 operate according to the calculated operating lengths l, with the reference point coordinate Tₜ at the target point.

Meanwhile, when the shield TBM has an X-type articulation system, the articulation jacks 3 are arranged with four jacks spaced apart around a rotation pin located at the center of the shield.

In this case, the sum of the operating lengths lᵤ and l_{d} of the upper and lower articulation jacks and the sum of the operating lengths lₗ and lᵣ of the left and right articulation jacks may be controlled to be constant so as to always become the maximum operating length. For example, when the operating range of each articulation jack 3 is 200 mm, the above-described sums may be constantly maintained at 200 mm. In this case, the amount of calculation performed by the artificial intelligence calculation model may be reduced, thereby enabling more simplified and yet highly accurate calculation.

The steering controller SC of the shield TBM and the steering control method CM using the same according to the present disclosure described above may be understood to be implementable in other specific forms by those of ordinary skill in the art to which the present disclosure pertains without changing the technical spirit or essential features of the present disclosure.

Therefore, the embodiments described above are illustrative in all aspects and should not be construed as limiting, and the scope of the present invention is indicated by the claims described below rather than the foregoing detailed description. All modifications or variations derived from the meaning, scope, and equivalent concepts of the claims should be interpreted as being included within the scope of the present invention.

[Description of reference numerals]

| | |
|---|---|
| 1: front shield | 2: middle shield |
| 3: articulation jack | 4: shield jack |
| 5: segment ring | |
| SC: steering controller | |

1. A steering control method CM using a steering controller SC of a shield tunnel boring machine (TBM), in which a steering controller SC of the shield TBM individually controls operating lengths l of at least four articulation jacks 3, the at least four articulation jacks 3 being provided between a front shield 1 having a cutter head 1a and a middle shield 2 along an excavation path and radially spaced at equal intervals, the method comprising:
extracting, by the steering controller SC, a reference point coordinate T_{c} of the cutter head 1a at a current point and a reference point coordinate Tₜ of the cutter head 1a at a target point according to one cycle operation of a shield jack 4 (S10);
calculating, by the steering controller SC, the operating lengths l of each articulation jack 3 as continuous real number values based on the reference point coordinate T_{c} at the current point and the reference point coordinate Tₜ at the target point using an artificial intelligence calculation model (S20); and
simultaneously operating, by the steering controller SC, the articulation jacks 3 based on the calculated operating lengths l (S40).

2. The steering control method CM using the steering controller SC of a shield TBM according to claim 1, further comprising:
receiving, by the steering controller SC, coordinates according to a pre-designed path of a three-dimensional tunnel (S00).

3. The steering control method CM using the steering controller SC of a shield TBM according to claim 1,
wherein the artificial intelligence calculation model is configured to calculate the operating lengths l of each articulation jack 3 within an operating range by receiving a diameter D of the cutter head 1a and articulation angles α and β based on reference point coordinates T_{c} and Tₜ of a current point and a target point as inputs.

4. The steering control method CM using the steering controller SC of a shield TBM according to claim 3,
wherein the artificial intelligence calculation model, which is a prediction model using a repetitive loop, comprises:
generating a random number for an operating length l within an operating range of each articulation jack 3 (S21A);
calculating articulation angles α_{cal} and β_{cal} corresponding to the operating length l of each articulation jack 3 based on the generated random number (S22A);
comparing the calculated articulation angles α_{cal} and β_{cal} with articulation angles αᵢₙ and βᵢₙ based on reference point coordinates T_{c} and Tₜ of a current point and a target point (S23A); and
extracting the generated random number as a valid operating length l of each articulation jack 3 when the calculated articulation angles α_{cal} and β_{cal} are within an error range, and returning to the step S21A of generating a new random number when the angles are outside the error range (S24A).

5. The steering control method CM using the steering controller SC of a shield TBM according to claim 4,
wherein the step S21A of generating the random number partially limits a generation range of the random number based on a valid operating length l of each articulation jack 3 extracted in a previous cycle.

6. The steering control method CM using the steering controller SC of a shield TBM according to claim 3,
wherein the artificial intelligence calculation model is a machine learning model for regression calculation generated by training a dataset including a diameter D and articulation angles α and β as input variables and an operating length l as an output variable.

7. The steering control method CM using the steering controller SC of a shield TBM according to claim 3, further comprising:
outputting, by the steering controller SC, the calculated operating lengths l of each articulation jack 3 to a display (S25).

8. The steering control method CM using the steering controller SC of a shield TBM according to claim 3, further comprising:
verifying, by the steering controller SC, whether to operate by comparing a predicted reference point coordinate Tₚ of the cutter head 1a, which is expected when each articulation jack 3 operates based on the calculated operating length l, with a reference point coordinate Tₜ of a target point (S30).

9. A steering controller SC of a shield tunnel boring machine (TBM), comprising: a memory in which an application program is stored to provide a steering control method for individually controlling operating lengths l of at least four articulation jacks 3 provided between a front shield 1 having a cutter head 1a and a middle shield 2 along an excavation path and radially spaced apart at equal intervals; and a processor configured to execute the application program stored in the memory,
wherein the processor, upon execution of the application program,
extracts a reference point coordinate T_{c} of a cutter head 1a at a current point and a reference point coordinate Tₜ of the cutter head 1a at a target point according to one cycle of operation of a shield jack 4,
calculates, using an artificial intelligence calculation model, the operating length l of each articulation jack 3 as a continuous real number value based on the reference point coordinate T_{c} of the current point and the reference point coordinate Tₜ of the target point,
verifies whether to operate by comparing a reference point coordinate Tₚ of the cutter head 1a predicted when each articulation jack 3 operate according to the calculated operating lengths l with the reference point coordinate Tₜ of the target point, and
simultaneously operates each articulation jack 3 according to the calculated operating lengths l.

10. The steering controller SC of a shield TBM according to claim 9,
wherein the four articulation jacks 3 are arranged spaced apart around a rotation pin located at the center of the shield, and the sum of the operating lengths lᵤ and l_{d} of an upper articulation jack and a lower articulation jack, and the sum of the operating lengths lₗ and lᵣ of a left articulation jack and a right articulation jack are always controlled to remain constant.
